(19) United States
(12) Patent Application Publication
(10) Pub. No.: US 2023/0030242 A1
(43) Pub. Date: Feb. 2, 2023

(54) FOLDING CELL PHONE CASE

(71) Applicant: Haimin Hu, Ninghai (CN)

(72) Inventor: Haimin Hu, Ninghai (CN)

(21) Appl. No.: 17/965,786

(22) Filed: Oct. 14, 2022

(30) Foreign Application Priority Data
Aug. 25, 2022 (CN) 202222247138.4

(51) Int. Cl. H04B 1/3888

(52) U.S. Cl. CPC H04B 1/3888; H04M 1/0214

(57) ABSTRACT

The present disclosure provides a folding cell phone case, and relates to the technical field of folding cell phone cases. The folding cell phone case includes an upper case, a lower case, and a hinge protection case; a springback plate is fixedly mounted inside the lower case; one end of the springback plate is fixedly connected to the hinge protection case; and a cylinder is fixedly arranged inside the hinge protection case. According to the present disclosure, by the arrangement of the hinge protection case, when a cell phone with a folding screen needs to be unfolded for use, a user only needs to flip the cell phone with the folding screen to rotate the hinge protection case, and fits the hinge protection case to the upper case under the pushing of the springback plate.

### TECHNICAL FIELD

The present disclosure relates to the technical field of folding cell phone cases, particularly to a folding cell phone case.

### BACKGROUND

During the use of a cell phone with a folding screen, in order to protect the cell phone with the folding screen, some users will mount a folding cell phone case on a surface of the cell phone with the folding screen. However, the existing folding cell phone cases are often split in use. In a use process, the folding cell phone case is often separately mounted on upper and lower screens of the cell phone with the folding screen. As a result, after the cell phone with the folding screen is folded, the cell phone case can usually only protect the upper and lower screens of the cell phone with the folding screen, and a fragile hinge rotating portion of the cell phone with the folding screen will often be directly exposed to the outside. Therefore, it is difficult for the cell phone case to protect the hinge rotating portion. The protection effect is poor.

### SUMMARY

The present disclosure aims to solve the shortcomings in the prior art, and provides a folding cell phone case.

In order to achieve the above-mentioned objective, the present disclosure adopts the following technical solution: a folding cell phone case includes an upper case, a lower case, and a hinge protection case, wherein a springback plate is fixedly mounted inside the lower case; one end of the springback plate is fixedly connected to the hinge protection case; a cylinder is fixedly arranged inside the hinge protection case; a magnetic block is fixedly arranged inside the cylinder; a camera opening and a button opening are respectively formed in a surface of the upper case; and a charging opening and a horn opening are respectively formed in a surface of the lower case.

In order to make the springback plate has good elasticity, according to an improvement of the present disclosure, a material of the springback plate is Thermoplastic Vulcanizate (TPV).

In order to make the upper case, the lower case and the hinge protection case have sufficient strength, according to an improvement of the present disclosure, materials of the upper case, the lower case and the hinge protection case are all polycarbonate (PC).

In order to achieve a better protection effect, according to an improvement of the present disclosure, soft rubber pads are fixedly arranged inside the upper case and the lower case.

In order to facilitate a user to hold the entire folding cell phone case and use it, according to an improvement of the present disclosure, patterns are arranged on outer surfaces of the upper case, the lower case and the hinge protection case.

In order to fix the hinge protection case, according to an improvement of the present disclosure, a screw sleeves a surface of the springback plate; and the springback plate is fixedly connected to the hinge protection case through the screw.

Compared with the prior art, the present disclosure has the advantages and beneficial effects:

According to the present disclosure, by the arrangement of the hinge protection case, when a cell phone with a folding screen needs to be unfolded for use, a user only needs to flip the cell phone with the folding screen to rotate the hinge protection case, and fits the hinge protection case to the upper case under the pushing of the springback plate. To fold the cell phone with the folding screen, the springback plate can pull the hinge protection case to rotate, and the magnetic block attracts an iron hinge portion of the cell phone with the folding screen, so that the hinge protection case can be wrapped around the hinge portion of the cell phone with the folding screen to prevent a hinge from being easily damaged in a folding storage process of the cell phone with the folding screen, thus achieving a good protection effect.

### BRIEF DESCRIPTION OF THE DRAWINGS

FIG. 1 is a schematic structural diagram of a front view of unfolding of a folding cell phone case provided according to the present disclosure;

FIG. 2 is a schematic structural diagram of a rear view of unfolding of a folding cell phone case provided according to the present disclosure;

FIG. 3 is a schematic structural diagram of folding of a folding cell phone case provided according to the present disclosure; and

FIG. 4 is an exploded diagram of a lower case of a folding cell phone case provided according to the present disclosure.

### ILLUSTRATIONS IN THE DRAWINGS

1: upper case; 2: lower case; 3: hinge protection case; 4: springback plate; 5: magnetic plate; 6: camera opening; 7: button opening; 8: charging opening; 9: horn opening; and 10: soft rubber pad.

### DETAILED DESCRIPTION OF THE EMBODIMENTS

In order to understand the above objectives, features and advantages of the present disclosure more clearly, the present disclosure will be further described below with reference to the accompanying drawings and embodiments. It should be noted that the embodiments of the present disclosure and features in the embodiments may be combined with each other without conflicts.

In the description of the present disclosure, it should be understood that orientations or positional relationships indicated by the terms “length”, “width”, “upper”, “lower”, “front”, “rear”, “left”, “right”, “vertical”, “horizontal”, “top”, “bottom”, “inside”, “outside” and the like are orientations or positional relationships as shown in the drawings, and are only for the purpose of facilitating and simplifying the description of the present disclosure instead of indicating or implying that devices or elements indicated must have particular orientations, and be constructed and operated in the particular orientations, so that these terms are not construed as limiting the present disclosure. In the description of the present disclosure, unless expressly specified otherwise, the meaning of the “plurality” is two or more than two.

### Embodiment I

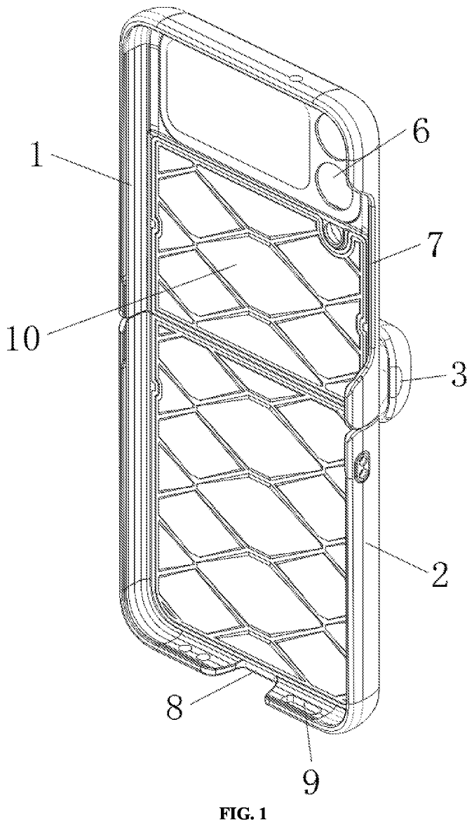

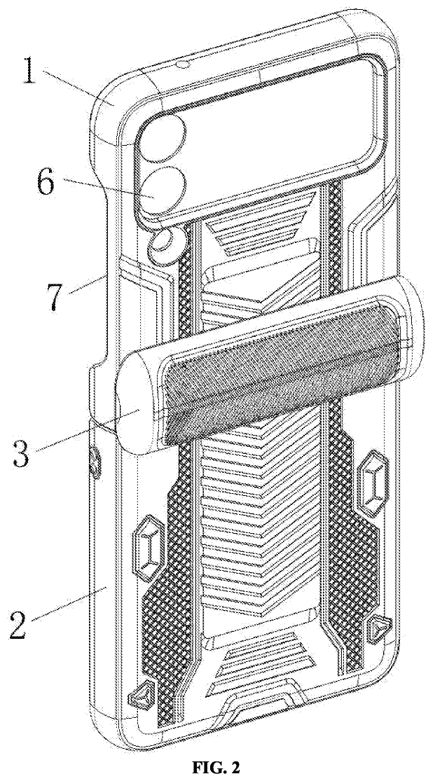

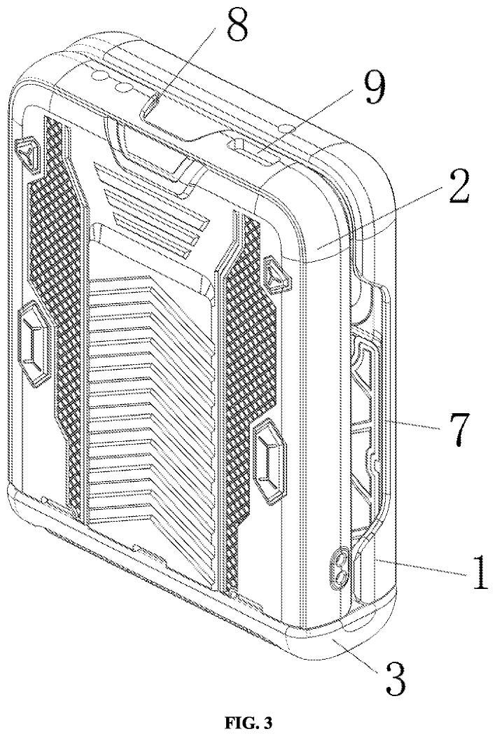

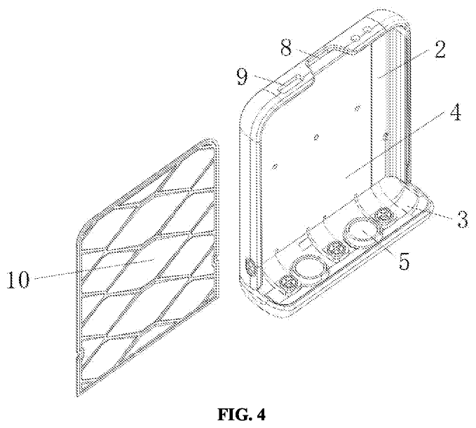

As shown in FIG. 1 to FIG. 4, the present disclosure provides a technical solution: A folding cell phone case includes an upper case 1, a lower case 2, and a hinge protection case 3. A springback plate 4 is fixedly mounted inside the lower case 2. One end of the springback plate 4 is fixedly connected to the hinge protection case 3. A cylinder is fixedly arranged inside the hinge protection case 3. A magnetic block 5 is fixedly arranged inside the cylinder. A camera opening 6 and a button opening 7 are respectively formed in a surface of the upper case 1. A charging opening 8 and a horn opening 9 are respectively formed in a surface of the lower case 2. The upper case 1 and the lower case 2 are common folding cell phone cases in the market. As common technical knowledge of those skilled in the art, their specific working principles and use methods are not repeatedly described herein. When a cell phone with a folding screen needs to be unfolded for use, a user only needs to flip the cell phone with the folding screen to rotate the hinge protection case 3, and fits the hinge protection case to the upper case 1 under the pushing of the springback plate 4. To fold the cell phone with the folding screen, the springback plate 4 can pull the hinge protection case 3 to rotate, and the magnetic block 5 attracts an iron hinge portion of the cell phone with the folding screen, so that the hinge protection case 3 can be wrapped around the hinge portion of the cell phone with the folding screen to prevent a hinge from being easily damaged in a folding storage process of the cell phone with the folding screen, thus achieving a good protection effect.

As shown in FIG. 1 to FIG. 4, a material of the springback plate 4 is TPV. The TPV has good elastic and toughness, so that the springback plate 4 can have long service life. Materials of the upper case 1, the lower case 2 and the hinge protection case 3 are all PC. The PC has enough strength, so that the upper case 1, the lower case 2 and the hinge protection case 3 can achieve a good protection effect. Soft rubber pads 10 are fixedly arranged inside the upper case 1 and the lower case 2. The soft rubber pads 10 can achieve a certain buffer effect, so that the cell phone with the folding screen can be well protected. Patterns are arranged on outer surfaces of the upper case 1, the lower case 2 and the hinge protection case 3. The patterns can increase a friction force between a hand and the case 1, the lower case 2, as well as the hinge protection case 3, so that the user can hold the entire folding cell phone case. A screw sleeves a surface of the springback plate 4; and the springback plate 4 is fixedly connected to the hinge protection case 3 through the screw, so that the user can screw out the screw to remove and replace the hinge protection case 3.

Working principle: During use, the user can respectively fasten the upper case 1 and the lower case 2 to a cell phone with a folding screen of the corresponding model number. To fold the cell phone with the folding screen, the springback plate 4 can pull the hinge protection case 3 to rotate, and the magnetic block 5 attracts an iron hinge portion of the cell phone with the folding screen, so that the hinge protection case 3 can be wrapped around the hinge portion of the cell phone with the folding screen to prevent a hinge from being easily damaged in a folding storage process of the cell phone with the folding screen. When the cell phone with the folding screen needs to be unfolded for use, the user only needs to flip the cell phone with the folding screen to enable the upper case 1 to extrude the hinge protection case 3, so that the hinge protection case 3 rotates at a joint with the springback plate 4 and is fitted to the upper case 1 under the pushing of the springback plate 4, thus preventing the hinge protection case 3 from easily rotating during use. The cell phone with the folding screen can be unfolded for use. The patterns can increase a friction force between a hand and the case 1, the lower case 2, as well as the hinge protection case 3, so that the user can hold the entire folding cell phone case. The soft rubber pads 10 can achieve a certain buffer effect, so that the cell phone with the folding screen can be well protected.

Only preferred embodiments of the present disclosure are described above, and are not intended to limit the present disclosure in other forms. Anyone skilled in the art can change or modify the technical content disclosed above into equivalently changed equivalent embodiments which are applied to other fields. However, any simple alterations, equivalent changes and modifications made to the above embodiments according to the technical essence of the present disclosure without departing from the content of the technical solutions of the present disclosure still fall within the protection scope of the technical solutions of the present disclosure.

What is claimed is:

1. A folding cell phone case, comprising an upper case (1), a lower case (2), and a hinge protection case (3), wherein a springback plate (4) is fixedly mounted inside the lower case (2); one end of the springback plate (4) is fixedly connected to the hinge protection case (3); a cylinder is fixedly arranged inside the hinge protection case (3); a magnetic block (5) is fixedly arranged inside the cylinder; a camera opening (6) and a button opening (7) are respectively formed in a surface of the upper case (1); and a charging opening (8) and a horn opening (9) are respectively formed in a surface of the lower case (2).

2. The folding cell phone case according to claim 1, wherein a material of the springback plate (4) is Thermoplastic Vulcanizate (TPV).

3. The folding cell phone case according to claim 1, wherein materials of the upper case (1), the lower case (2) and the hinge protection case (3) are all polycarbonate (PC).

4. The folding cell phone case according to claim 1, wherein soft rubber pads (10) are fixedly arranged inside the upper case (1) and the lower case (2).

5. The folding cell phone case according to claim 1, wherein patterns are arranged on outer surfaces of the upper case (1), the lower case (2) and the hinge protection case (3).

6. The folding cell phone case according to claim 1, wherein a screw sleeves a surface of the springback plate (4); and the springback plate (4) is fixedly connected to the hinge protection case (3) through the screw.
